(19) United States
(12) Patent Application Publication
(10) Pub. No.: US 2026/0302396 A1
(43) Pub. Date: Oct. 1, 2026

(54) METHOD OF PREPARING POSITIVE ELECTRODE ACTIVE MATERIAL FOR SECONDARY BATTERY USING WASTE BATTERY AND POSITIVE ELECTRODE ACTIVE MATERIAL FOR SECONDARY BATTERY PREPARED THEREBY

(71) Applicant: HANWHA CORPORATION, Seoul (KR)

(72) Inventors: Kyung Jung Kwon, Seoul (KR); Gi Gap Han, Seoul (KR); Chan Min Kim, Seoul (KR); Jung Wook Choi, Yongin-si (KR); Jun Sang Yoo, Ulsan (KR); Chan Mi Jeon, Seoul (KR)

(73) Assignee: HANWHA CORPORATION, Seoul (KR)

(21) Appl. No.: 19/203,469

(22) Filed: May 9, 2025

(30) Foreign Application Priority Data
Mar. 27, 2025 (KR) 10-2025-0039323

(51) Int. Cl. H01M 10/54; C01G 53/506; C22B 7/00

(52) U.S. Cl. CPC H01M 10/54; C01G 53/506; C22B 7/001; C22B 7/008; C01P 2002/30; C01P 2004/03; C01P 2004/51; C01P 2006/40

(57) ABSTRACT

Proposed are a method of preparing a positive electrode active material for a secondary battery using a waste battery and a positive electrode active material for a secondary battery prepared thereby. The method includes removing a current collector from a waste positive electrode of a waste battery to recover a solidified waste positive electrode active material, performing a first heat treatment on the recovered waste positive electrode active material to remove a binder and a conductive additive while forming rock-salt structure single crystals by thermal instability, and performing a second heat treatment at a temperature higher than a first heat treatment temperature to obtain a regenerated positive electrode active material, after performing the first heat treatment. Accordingly, the preparation process is simplified by omitting leachate treatment and directly recycling the waste positive electrode active material to regenerate the positive electrode active material, reducing manufacturing costs and significantly improving economic feasibility.

### CROSS REFERENCE TO RELATED APPLICATION

The present application claims priority to Korean Patent Application No. 10-2025-0039323, filed Mar. 27, 2025, the entire contents of which is incorporated herein for all purposes by this reference.

### BACKGROUND

### Technical Field

The present disclosure relates to a method of preparing a positive electrode active material for a secondary battery using a waste battery and to a positive electrode active material for a secondary battery prepared thereby. M ore particularly, the present disclosure relates to a method of preparing a positive electrode active material for a secondary battery using a waste battery, the method simplifying a preparation process of the positive electrode active material for the secondary battery using the waste battery, and to a positive electrode active material for a secondary battery prepared thereby.

### Description of the Related Art

Recently, with the increasing demand for eco-friendly energy due to global warming, there has been a rapidly growing demand for secondary batteries in electric vehicles and the like.

In particular, as the market for electric vehicles grows, the use of battery packs having high capacitance is increasing by involving a plurality of unit battery cells.

Accordingly, this leads to an expectation that waste battery packs resulting from electric vehicles are likely to increase rapidly, and the need for recycling waste batteries grows to effectively utilize limited resources.

As a patent document in the related art, Korean Patent No. 10-1440241 “NCA-BASED POSITIVE ELECTRODE ACTIVE MATERIAL FOR LITHIUM SECONDARY BATTERY, METHOD OF PREPARING SAME POSITIVE ELECTRODE ACTIVE MATERIAL, AND LITHIUM SECONDARY BATTERY INCLUDING SAME POSITIVE ELECTRODE ACTIVE MATERIAL” has been proposed.

However, Korean Patent No. 10-1440241 “NCA-BASED POSITIVE ELECTRODE ACTIVE MATERIAL FOR LITHIUM SECONDARY BATTERY, METHOD OF PREPARING SAME POSITIVE ELECTRODE ACTIVE MATERIAL, AND LITHIUM SECONDARY BATTERY INCLUDING SAME POSITIVE ELECTRODE ACTIVE MATERIAL” involves preparing a Ni-rich positive electrode active material, which is characterized by having a high capacity using co-precipitation of a hydroxide salt, by synthesizing a precursor through co-precipitation of nickel and cobalt, which has been problematic in terms of environmental unfriendliness due to requiring increased manufacturing costs and not using waste batteries.

To solve such problems, Korean Patent Application Publication No. 10-2013-0048811 “METHOD OF PREPARING POSITIVE ELECTRODE ACTIVE MATERIAL FROM WASTE BATTERY” has been proposed.

Korean Patent Application Publication No. 10-2013-0048811 “METHOD OF PREPARING POSITIVE ELECTRODE ACTIVE MATERIAL FROM WASTE BATTERY” involves obtaining a precious metal powder including lithium, nickel, cobalt, and manganese from a waste battery, obtaining a leachate by leaching the precious metal powder through acid leaching in a reducing atmosphere, obtaining a hydroxide including at least nickel, cobalt, and manganese from the leachate, and obtaining a positive electrode active material by mixing the hydroxide and lithium carbonate and heat-treating the resulting mixture, thus preparing a positive electrode active material from a waste battery.

However, Korean Patent Application Publication No. 10-2013-0048811 “METHOD OF PREPARING POSITIVE ELECTRODE ACTIVE MATERIAL FROM WASTE BATTERY” has been problematic in that the preparation process is complicated because the positive electrode active material is prepared after producing the leachate using the precious metal powder obtained from the waste battery, and the leachate poses significant environmental risks.

Additionally, Korean Patent Application Publication No. 10-2013-0048811 “METHOD OF PREPARING POSITIVE ELECTRODE ACTIVE MATERIAL FROM WASTE BATTERY” has been disadvantageous in that the preparation process is complicated because the positive electrode active material is prepared after producing the leachate using the precious metal powder, resulting in insignificant economic feasibility in recycling batteries due to requiring increased manufacturing costs.

Furthermore, in positive electrode active materials used in currently available waste batteries, two or three positive electrode active materials that differ in size or crystallinity are mixed for use. While those, for example, having a large particle size of 12 μm or a small particle size of 3 μm are mixed at specific proportions to increase energy density, sorting positive electrode active materials having such a complicated structure is challenging. Additionally, the particle size of positive electrode active materials directly recycled from such positive electrode active materials is unlikely to show uniformity, which has been problematic.

To address such problems, involving transformation into single crystals through comminution is considered. However, such mechanical grinding requires a lot of time and costs, which has been problematic.

### DOCUMENTS OF RELATED ART

### Patent Documents

(Patent Document 1) Korean Patent No. 10-1440241 “NCA-BASED POSITIVE ELECTRODE ACTIVE MATERIAL FOR LITHIUM SECONDARY BATTERY, METHOD OF PREPARING SAME POSITIVE ELECTRODE ACTIVE MATERIAL, AND LITHIUM SECONDARY BATTERY INCLUDING SAME POSITIVE ELECTRODE ACTIVE MATERIAL” (registered on Sep. 3, 2014)
(Patent Document 2) Korean Patent Application Publication No. 10-2013-0048811 “METHOD OF PREPARING POSITIVE ELECTRODE ACTIVE MATERIAL FROM WASTE BATTERY” (published on May 13, 2013)

### SUMMARY

The present disclosure aims to provide a method of preparing a positive electrode active material for a secondary battery using a waste battery, in which a positive electrode active material regenerated by adjusting the lithium (Li) content in a waste positive electrode active material extracted from the waste battery is transformed into rock-salt structure single crystals, thus realizing an excellent capacity retention rate, and single-crystalline particles are uniformly formed without requiring a separate grinding process for single-crystal formation, and a positive electrode active material for a secondary battery prepared thereby.

To achieve the objectives as described above, one embodiment of a method of preparing a positive electrode active material for a secondary battery using a waste battery, according to the present disclosure, is characterized by including: removing a current collector from a waste positive electrode of a waste battery to recover a solidified waste positive electrode active material; performing a first heat treatment on the recovered waste positive electrode active material to remove a binder and a conductive additive while forming rock-salt structure single crystals by thermal instability; and performing a second heat treatment at a temperature higher than a first heat treatment temperature to obtain a regenerated positive electrode active material, after performing the first heat treatment.

In the present disclosure, removing the current collector may include: a treatment process with sodium hydroxide (NaOH) by immersing the waste positive electrode separated from the waste battery in a NaOH solution to dissolve an aluminum (Al) current collector, thus solidifying the waste positive electrode active material; and a washing process of the solidified waste positive electrode active material to remove Na and Al residues from the waste positive electrode active material.

In the present disclosure, performing the first heat treatment may be to heat-treat the waste positive electrode active material at a temperature in a range of 400° C. to 600° C. to transform Li into the rock-salt structure single crystals, wherein the heat-treated waste positive electrode active material may have a Li content in a range of 49 mol % to 81 mol %.

In the present disclosure, after performing the first heat treatment, a phase fraction of the rock-salt structure in the waste positive electrode active material may be in a range of 31% to 85%.

In the present disclosure, performing the first heat treatment may be to heat-treat the waste positive electrode active material at a temperature in a range of 400° C. to 600° C. to transform Li into the rock-salt structure single crystals, wherein the heat-treated waste positive electrode active material may have a Li content in a range of 49 mol % to 70 mol %.

In the present disclosure, after performing the first heat treatment, a phase fraction of the rock-salt structure in the waste positive electrode active material may be in a range of 43% to 85%.

One embodiment of the method of preparing the positive electrode active material for the secondary battery using the waste battery, according to the present disclosure, may further include adjusting a Li content in the waste positive electrode active material before performing the first heat treatment.

In the present disclosure, adjusting the Li content may be to adjust the Li content in the waste positive electrode active material to a range of 49 mol % to 81 mol %.

In the present disclosure, adjusting the Li content may be to determine the Li content in the waste positive electrode active material, recovered by removing the current collector, and supplement Li or remove some Li through elution.

In the present disclosure, adjusting the Li content may be to determine a state of charge (SOC) level of the waste battery before removing the current collector, and adjust the SOC level of the waste battery to a range of 20% to 60%.

In the present disclosure, adjusting the Li content may be to determine an SOC level of the waste battery before removing the current collector, and adjust the SOC level of the waste battery to a range of 40% to 60%.

In the present disclosure, performing the second heat treatment may include: a mixing process of Li by mixing the waste positive electrode active material with a Li source or a Li salt to supplement Li lost from the waste positive electrode active material transformed into the rock-salt structure single crystals; and a process of performing the second heat treatment through regenerative heat treatment at a temperature in a range of 480° C. to 950° C., the temperature being higher than the first heat treatment temperature, to regenerate the waste positive electrode active material, after the mixing process.

Additionally, to achieve the objectives as described above, a positive electrode active material for a secondary battery using a waste battery, according to the present disclosure, is characterized by being prepared by any one embodiment of the method of preparing the positive electrode active material for the secondary battery using the waste battery, according to the present disclosure.

The present disclosure can simplify the preparation process by omitting leachate treatment when preparing a positive electrode active material from a waste battery and directly recycling a waste positive electrode active material solidified from the waste battery to regenerate the positive electrode active material, thus reducing manufacturing costs and significantly improving economic feasibility when recycling the waste battery.

The present disclosure can realize an excellent capacity retention rate by transforming the positive electrode active material regenerated through the adjustment of the Li content in the waste positive electrode active material extracted from the waste battery, into rock-salt structure single crystals, thus improving the performance of the positive electrode active material regenerated from the waste battery, and can increase the recycling rate.

Additionally, the present disclosure can reduce manufacturing costs and manufacturing time by uniformly forming single-crystalline particles to have a particle size in the range of 3 μm to 7 μm without requiring a separate grinding process for single-crystal formation.

### BRIEF DESCRIPTION OF THE DRAWINGS

FIG. 1 is a flowchart illustrating one embodiment of a method of preparing a positive electrode active material for a secondary battery using a waste battery, according to the present disclosure;

FIG. 2 is a flowchart illustrating another embodiment of a method of preparing a positive electrode active material for a secondary battery using a waste battery, according to the present disclosure;

FIG. 3 is a graph showing temperature-dependent weight changes due to the removal of a conductive additive and a binder by performing a first heat treatment in an argon (Ar) gas atmosphere in a method of preparing a positive electrode active material for a secondary battery using a waste battery, according to the present disclosure;

FIG. 4 is a graph showing temperature-dependent weight changes due to the removal of a conductive additive and a binder by performing a first heat treatment in an air atmosphere in a method of preparing a positive electrode active material for a secondary battery using a waste battery, according to the present disclosure;

FIG. 5 is a scanning electron microscope image showing an enlarged particle structure in the case of Comparative Example 1 after a first heat treatment in a method of preparing a positive electrode active material for a secondary battery using a waste battery, according to the present disclosure;

FIG. 6 is a scanning electron microscope image showing an enlarged particle structure in the case of Example 2 after a first heat treatment in a method of preparing a positive electrode active material for a secondary battery using a waste battery, according to the present disclosure;

FIG. 7 is a graph showing particle size distributions in the case of Comparative Example 1, Example 1, and Example 2 in a method of preparing a positive electrode active material for a secondary battery using a waste battery, according to the present disclosure;

FIG. 8 is a graph showing test results of capacity development in the case of Comparative Example 1, Example 1, Example 2, and Comparative Example 2 in a method of preparing a positive electrode active material for a secondary battery using a waste battery, according to the present disclosure; and

FIG. 9 is a graph showing test results of capacity retention rates (%) at 80 cycles in the case of Comparative Example 1, Example 1, Example 2, and Comparative Example 2 in a method of preparing a positive electrode active material for a secondary battery using a waste battery, according to the present disclosure.

### DETAILED DESCRIPTION

Hereinafter, preferred embodiments of the present disclosure will be described in more detail with reference to the accompanying drawings. However, the technical spirit of the present disclosure is not limited to the embodiments described herein, and the embodiments of the present disclosure may be modified in various forms. The embodiments described herein are provided so that the present disclosure can be made thorough and complete and that the spirit of the present disclosure can be fully conveyed to those skilled in the art.

Additionally, in describing the present disclosure below, if it is determined that a detailed description of a related known function or configuration may unnecessarily obscure the gist of the present disclosure, the detailed description thereof will be omitted.

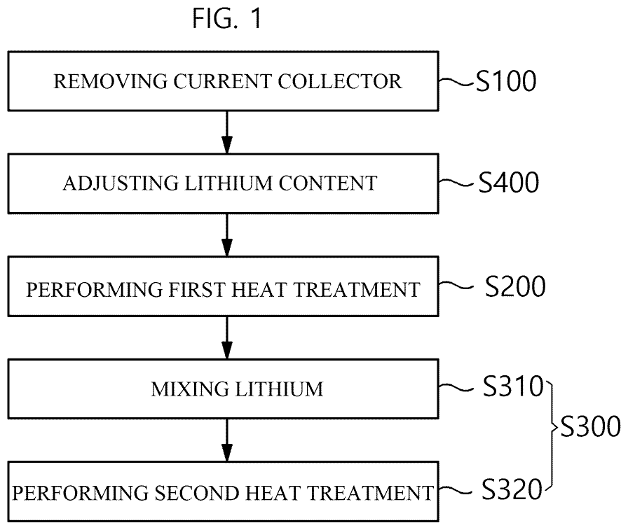

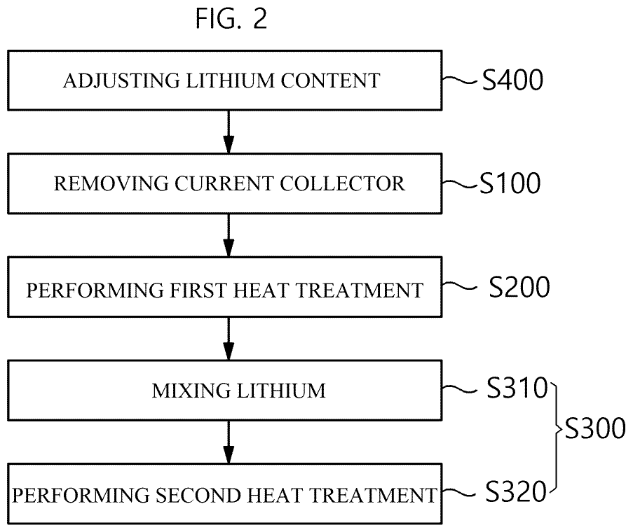

FIG. 1 is a flowchart illustrating one embodiment of a method of preparing a positive electrode active material for a secondary battery using a waste battery, according to the present disclosure, which shows one example where S400 of adjusting the Li content is performed after S100 of removing a current collector and before S200 of performing a first heat treatment, and FIG. 2 shows another example where S400 is performed before S100.

Referring to FIGS. 1 and 2, embodiments of the method of preparing a positive electrode active material for a secondary battery using a waste battery, according to the present disclosure, are to be described in detail below.

One embodiment of the method of preparing a positive electrode active material for a secondary battery using a waste battery, according to the present disclosure, includes: S100 of removing a current collector from a waste positive electrode of a waste battery to recover a solidified waste positive electrode active material; S200 of performing a first heat treatment on the recovered waste positive electrode active material to remove a binder and a conductive additive while forming rock-salt structure single crystals by thermal instability; and S300 of performing a second heat treatment at a temperature higher than a first heat treatment temperature to obtain a regenerated positive electrode active material, after S200.

S100 includes: a treatment process with sodium hydroxide (NaOH) by immersing the waste positive electrode separated from the waste battery in a NaOH solution to dissolve an aluminum (Al) current collector, thus solidifying the waste positive electrode active material; and a washing process of the solidified waste positive electrode active material.

The washing process removes Na and Al residues from the waste positive electrode active material after the treatment process.

The washing process is performed 1 to 4 times to remove the Na and Al residues from the waste positive electrode active material.

A first washing process removes some of the Na residues and the Al residues from the waste positive electrode active material, and a second, third, or fourth washing process ultimately removes the remaining Na residues.

The waste positive electrode active material, solidified and recovered in S100, includes parts of the conductive additive and the binder, and S200 is to heat-treat the waste positive electrode active material, having undergone the washing process, at a temperature in the range of 400° C. to 600° C., thus removing the binder and the conductive additive from the waste positive electrode active material.

Additionally, S200 is to heat-treat the waste positive electrode active material at a temperature in the range of 400° C. to 600° C., thus not only removing the binder and the conductive additive from the waste positive electrode active material but also transforming lithium (Li) into the rock-salt structure single crystals by thermal instability.

The waste positive electrode active material in S200 has a Li content in the range of 49 mol % to 81 mol %. Thus, after S200, the phase fraction of the rock-salt structure is exhibited in the range of 31% to 85%.

Additionally, the waste positive electrode active material in S200 has a Li content in the range of 49 mol % to 70 mol %. Thus, after S200, the phase fraction of the rock-salt structure is exhibited in the range of 43% to 85%.

When the phase fraction is 92% or higher, the rock-salt structure develops a low capacity and realizes a low capacity retention rate. Thus, the phase fraction of the rock-salt structure is preferably 92% or lower.

In the meantime, one embodiment of the method of preparing the positive electrode active material for the secondary battery using the waste battery, according to the present disclosure, further includes S400 of adjusting the Li content in the waste positive electrode active material before S200.

In one embodiment of the method of preparing the positive electrode active material for the secondary battery using the waste battery, according to the present disclosure, the Li content is adjusted to the range of 49 mol % to 81 mol % through S400.

S400 is to adjust the Li content in the waste positive electrode active material to the range of 49 mol % to 81 mol %, thus enabling Li to be transformed into the rock-salt structure single crystals having an appropriate phase fraction during S200.

S400 is to determine the Li content in the waste positive electrode active material recovered by S100. When the Li content is determined to be less than 49 mol %, the Li content is adjusted to the range of 49 mol % to 81 mol %, preferably in the range of 49 mol % to 70 mol %, by an additional process of supplementing Li.

Additionally, S400 is to determine the Li content in the waste positive electrode active material recovered by S100. When the Li content is determined to exceed 81 mol %, the Li content is adjusted to the range of 49 mol % to 81 mol %, preferably in the range of 49 mol % to 70 mol %, by an elution process of removing some Li.

The elution process is illustrated as eluting and removing some Li by a washing process using an acid solution but may be performed by various modifications using known methods of eluting and removing Li, so a further detailed description thereof is to be omitted.

Table 1 below shows test results of measuring the contents of the respective Li, nickel (Ni), cobalt (Co), and Al elements in the waste positive electrode active material with varying state of charge (SOC) levels of the waste battery.

TABLE 1

| | SOC (0% to | SOC (20% to | SOC (40% to | SOC (60% to |
|---|---|---|---|---|
| Element | 20%) | 40%) | 60%) | 100%) |
| Li | 80.37 to | 69.98 to | 49.94 to | 32.44 to |
| | 94.90 mol % | 80.37 mol % | 69.98 mol % | 49.94 mol % |
| Ni | 87.52 mol % | 87.38 mol % | 87.40 mol % | 87.39 mol % |
| Co | 10.62 mol % | 10.56 mol % | 10.96 mol % | 11.06 mol % |
| Al | 1.86 mol % | 2.06 mol % | 1.64 mol % | 1.54 mol % |

Accordingly, S400 is to determine the SOC level of the waste battery before S100, and adjust the SOC level of the waste battery to the range of 20% to 60%, thus enabling the Li content in the waste positive electrode active material recovered by S100 to fall within the range of 49 mol % to 81 mol %.

Preferably, S400 is to determine the SOC level of the waste battery before S100, and adjust the SOC level of the waste battery to the range of 40% to 60%, thus enabling the Li content in the waste positive electrode active material recovered by S100 to fall within the range of 49 mol % to 70 mol %.

S200 is to heat-treat the waste positive electrode active material, the Li content of which is in the range of 49 mol % to 81 mol %, at a temperature in the range of 400° C. to 600° C. in an air atmosphere, thus transforming Li into the rock-salt structure single crystals.

The waste positive electrode active material, having undergone S200, is transformed into the rock-salt structure single crystals, which have a particle size in the range of 3 μm to 7 μm.

S200 is to heat-treat the waste positive electrode active material, the Li content of which is in the range of 49 mol % to 81 mol %, at a temperature in the range of 400° C. to 600° C., thus transforming a layered structure into the rock-salt structure by thermal instability. This enables single crystals having a particle size in the range of 3 μm to 7 μm to be prepared by heat treatment without requiring mechanical grinding.

Preferably, S200 is to heat-treat the waste positive electrode active material, the Li content of which is in the range of 49.94 mol % to 70 mol %, at a temperature in the range of 400° C. to 600° C., thus transforming the layered structure into the rock-salt structure by thermal instability. This enables single crystals having a particle size in the range of 3 μm to 7 μm to be prepared by heat treatment without requiring mechanical grinding.

S300 includes: S310 of mixing Li by mixing the waste positive electrode active material with a Li source or a Li salt to supplement Li lost from the waste positive electrode active material transformed into the rock-salt structure single crystals; and S320 of performing the second heat treatment through regenerative heat treatment at a temperature in the range of 480° C. to 950° C., the temperature being higher than the first heat treatment temperature, to regenerate the waste positive electrode active material, after S310. Through S320, the regenerated positive electrode active material is prepared.

S310 is to supplement and mix Li lost from the waste positive electrode active material after S200. However, the amount of the Li source or the Li salt supplemented is adjusted by targeting the Li content in the positive electrode active material to the range of 100 mol % to 105 mol %.

In one example, in S310, when the Li content in the positive electrode active material, transformed into the rock-salt structure single crystals by S200, is 49.94 mol %, 50.06 mol % to 55.06 mol % of Li may be additionally supplemented.

Table 2 below shows the contents of the respective elements in the waste positive electrode active material after S200 and before regeneration, and the content of respective elements in the waste positive electrode active material regenerated by undergoing S310 to supplement the Li source and the Li salt for the Li loss and undergoing S320.

TABLE 2

| | Positive electrode active material before regeneration | | | | Positive electrode active material after regeneration | | | |
|---|---|---|---|---|---|---|---|---|
| | (mol %) | | | | (mol %) | | | |
| Li | 66.21 mol % | 58.43 mol % | 33.19 mol % | 17.48 mol % | 99.52 mol % | 103.37 mol % | 101.65 mol % | 101.56 mol % |
| Ni | 87.54 mol % | 87.72 mol % | 87.08 mol % | 87.15 mol % | 87.34 mol % | 87.75 mol % | 87.35 mol % | 86.37 mol % |
| Co | 10.86 mol % | 10.63 mol % | 11.22 mol % | 11.01 mol % | 10.92 mol % | 10.61 mol % | 11.11 mol % | 12.10 mol % |
| Al | 1.60 mol % | 1.65 mol % | 1.70 mol % | 1.84 mol % | 1.74 mol % | 1.65 mol % | 1.54 mol % | 1.53 mol % |

Table 2 is for the reference of the amount of Li additionally supplied in S310. In S310, Li is supplemented to satisfy the Li content in known positive electrode active materials, so a further detailed description thereof is to be omitted.

In the present disclosure, Example 1 is one example of a waste positive electrode active material the Li content of which is adjusted to the range of 70 mol % to 81 mol % before S200, and Example 2 is one example of a waste positive electrode active material the Li content of which is adjusted to the range of 49 mol % to 70 mol % before S200.

Additionally, Comparative Example 1 is one example of a waste positive electrode active material the Li content of which is adjusted to the range of 81 mol % to 95 mol % before S200, and Comparative Example 2 is one example of a waste positive electrode active material the Li content which is adjusted to the range of 32 mol % to 49 mol % before S200.

In other words, Comparative Examples 1 and 2 are examples of the waste positive electrode active materials each Li content of which does not fall within the range of 49 mol % to 81 mol % before S200.

Table 3 below shows the contents of the respective Li, Ni, Co, and Al elements in each of the waste positive electrode active materials of Example 1, Example 2, Comparative Example 1, and Comparative Example 2 of the present disclosure.

TABLE 3

| | Comparative | | | Comparative |
|---|---|---|---|---|
| Element | Example 1 | Example 1 | Example 2 | Example 2 |
| Li | 80.37 to | 69.98 to | 49.94 to | 32.44 to |
| | 94.90 mol % | 80.37 mol % | 69.98 mol % | 49.94 mol % |
| Ni | 87.52 mol % | 87.38 mol % | 87.40 mol % | 87.39 mol % |
| Co | 10.62 mol % | 10.56 mol % | 10.96 mol % | 11.06 mol % |
| Al | 1.86 mol % | 2.06 mol % | 1.64 mol % | 1.54 mol % |

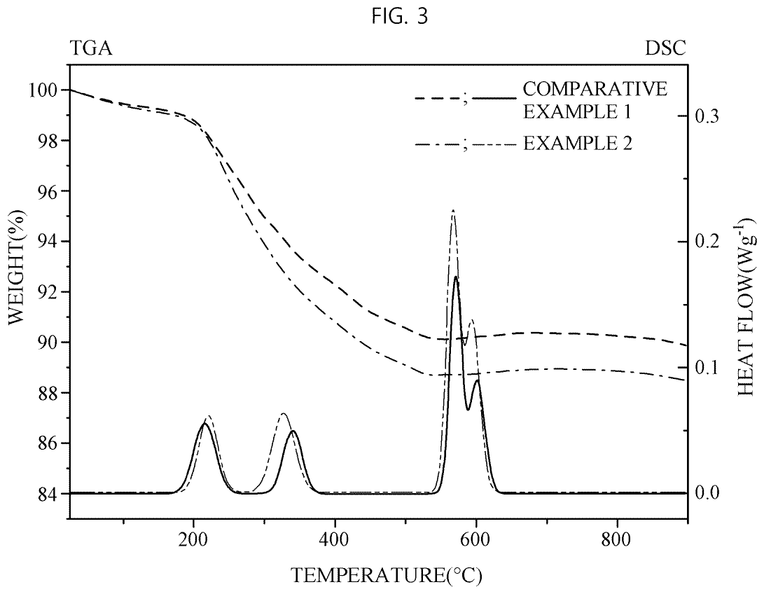

It should be noted that the values in FIGS. 3 to 9 and Table 4 below, showing test data of Comparative Example 1, Example 1, Example 2, and Comparative Example 2, refer to the average values within each Li content range.

In other words, in FIGS. 3 to 9 and Table 4, the test data of Comparative Example 1 show the average value obtained when the Li content varies within the range of 80.37 mol % to 94.90 mol % while the contents of Ni, Co, and Al are fixed at 87.52 mol %, 10.62 mol %, and 1.86 mol %, respectively. Additionally, the test data of Comparative Example 2 show the average value obtained when the Li content varies within the range of 32.44 mol % to 49.94 mol % while the contents of Ni, Co, and Al are fixed at 87.39 mol %, 11.06 mol %, and 1.54 mol %, respectively.

Furthermore, in FIGS. 3 to 9 and Table 4, the test data of Example 1 show the average value obtained when the Li content varies within the range of 69.98 mol % to 80.37 mol % while the contents of Ni, Co, and Al are fixed at 87.38 mol %, 10.56 mol %, and 2.06 mol %, respectively. Additionally, the test data of Example 2 show the average value obtained when the Li content varies within the range of 49.94 mol % to 69.98 mol % while the contents of Ni, Co, and Al are fixed at 87.40 mol %, 10.96 mol %, and 1.64 mol %, respectively.

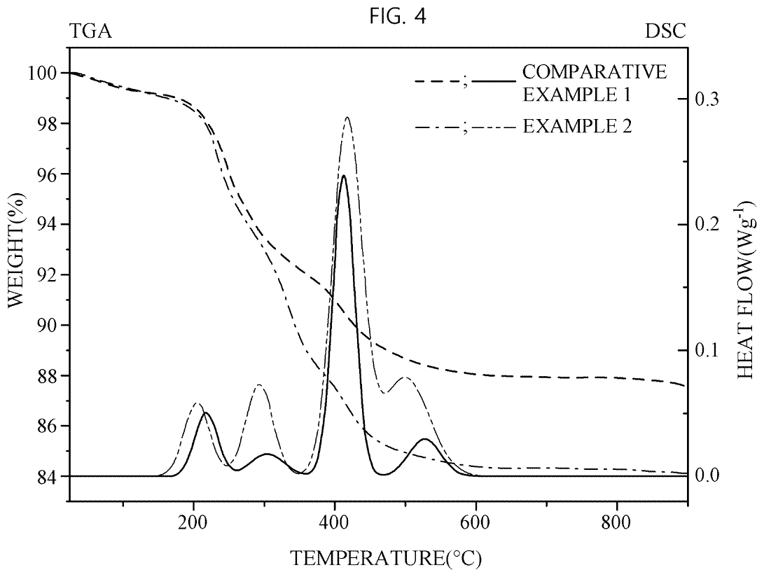

In the meantime, FIG. 3 is a graph showing temperature-dependent weight changes due to the removal of the conductive additive and the binder by performing S200 in an Ar gas atmosphere, and FIG. 4 is a graph showing temperature-dependent weight changes due to the removal of the conductive additive and the binder by performing S200 in an air atmosphere. FIGS. 3 and 4 are graphs showing the weight changes in the case of Comparative Example 1 and Example 2.

When comparing Comparative Example 1 and Example 2 of the present disclosure with reference to FIGS. 3 and 4, the waste positive electrode active material of Example 2 of the present disclosure exhibits a lower degree of discharge and has a lower Li content than the waste positive electrode active material of Comparative Example 1. As a result, it was confirmed that greater peaks and more phase transitions occurred.

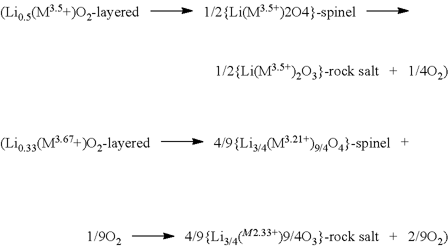

Additionally, the peaks observed at temperatures of 300° C. or higher are confirmed to occur as exothermic peaks generated upon the decomposition of the binder as well as the phase transition (CH₂CF₂+O₂->2CO₂+2HF).

In an air atmosphere, carbon (C), the primary component of the conductive additive, is oxidized to CO₂ at lower temperatures, thus facilitating the conductive additive to be more easily removed than in an Ar gas atmosphere. Additionally, in an air atmosphere, the weight loss is insignificant at temperatures of 500° C. or higher, so the first heat treatment temperature is preferably in the range of 400° C. to 600° C.

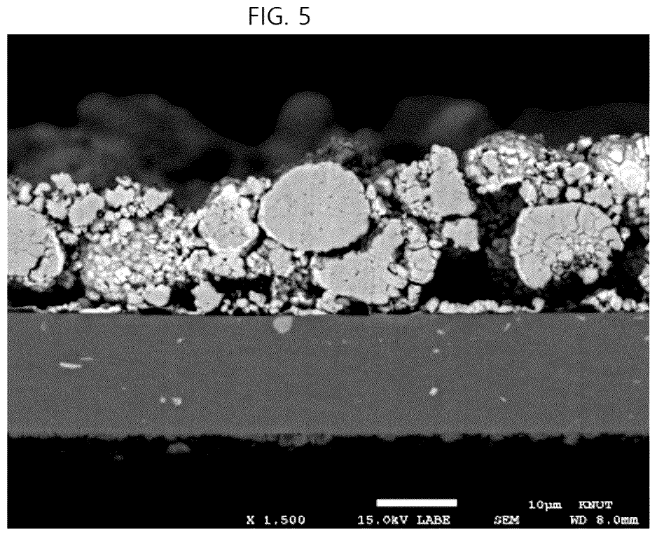

FIG. 5 and Table 4 below show the phase fractions of the layered structure and the rock-salt structure in the case of Example 1, Example 2, Comparative Example 1, and Comparative Example 2 of the present disclosure, after S200.

TABLE 4

| | Comparative | | | Comparative |
|---|---|---|---|---|
| Classification | Example 1 | Example 1 | Example 2 | Example 2 |
| Layered structure | 98.7% | 69.3% | 26.8% | 2.5% |
| Rock-salt structure | 1.3% | 31.7% | 73.2% | 97.5% |

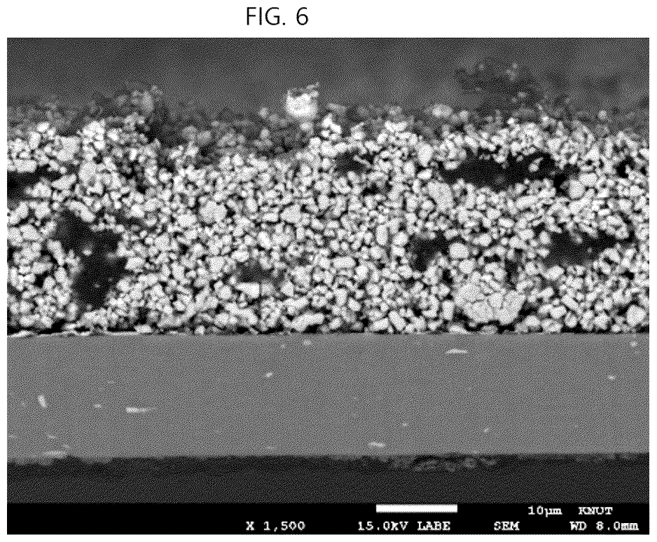

Additionally, FIG. 5 is a scanning electron microscope image showing an enlarged particle structure in the case of Comparative Example 1 after S200, and FIG. 6 is a scanning electron microscope image showing an enlarged particle structure in the case of Example 2 after S200.

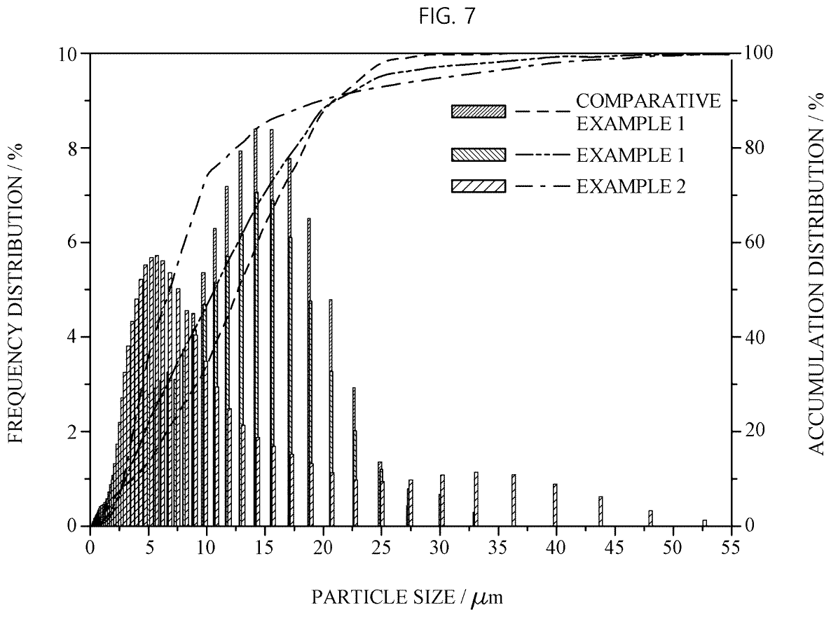

Furthermore, FIG. 7 is a graph showing particle size distributions in the case of Comparative Example 1, Example 1, and Example 2 of the present disclosure.

Referring to FIGS. 5, 6, and 7, it was confirmed that Comparative Example 1 was composed primarily of polycrystalline particles having a particle size in the range of 15 μm to 20 μm, and Example 2 was composed primarily of single-crystalline particles having a particle size in the range of 3 μm to 7 μm. Additionally, it was confirmed that in Example 1, single-crystalline particles having a particle size in the range of 3 μm to 7 μm and polycrystalline particles having a particle size in the range of 15 μm to 20 μm were mixed.

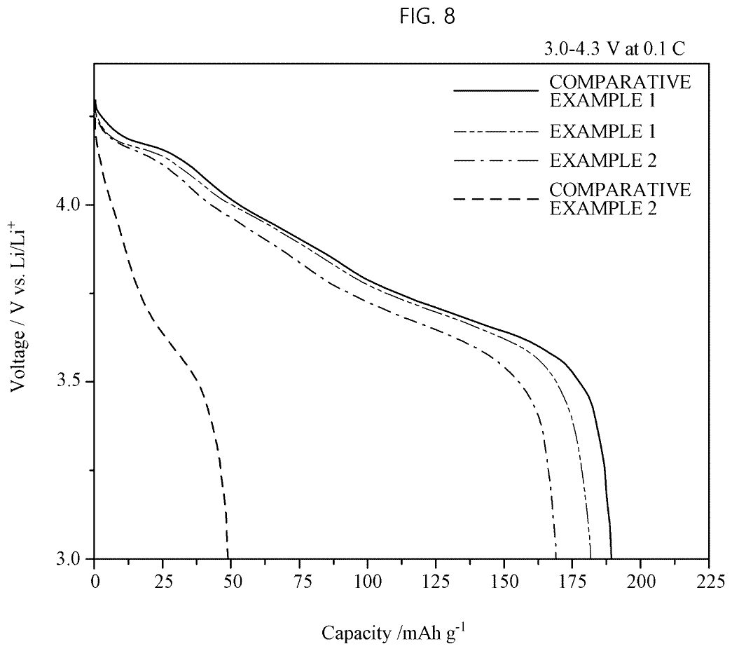

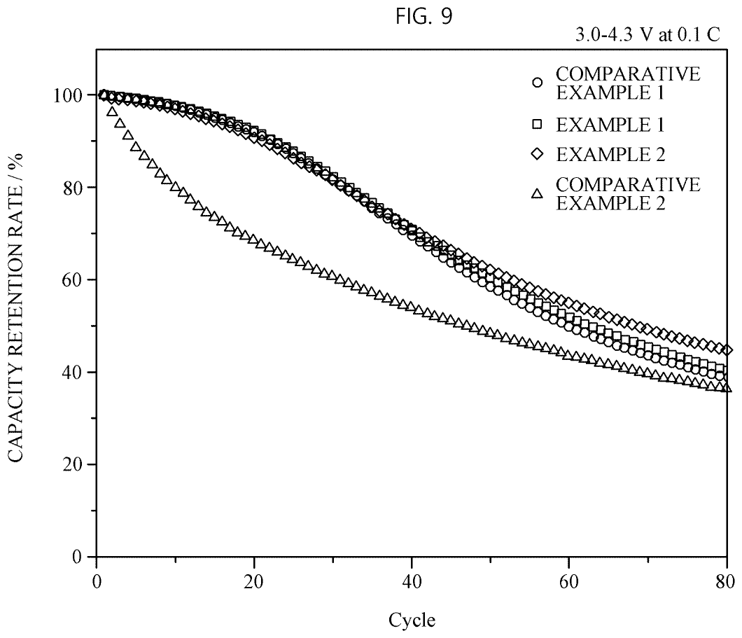

Additionally, FIG. 8 is a graph showing test results of capacity development in the case of Comparative Example 1, Example 1, Example 2, and Comparative Example 2 of the present disclosure, and FIG. 9 is a graph showing test results of capacity retention rates (%) at 80 cycles in the case of Comparative Example 1, Example 1, Example 2, and Comparative Example 2 of the present disclosure.

It was confirmed from FIG. 9 that the capacity retention rates (%) were 38.9% in the case of Comparative Example 1, 36.6% in the case of Comparative Example 2, 40.5% in the case of Example 1, and 44.9% in the case of Example 2.

As confirmed from FIGS. 8 and 9, in the case of Comparative Example 1, in which the phase fraction of the rock-salt structure was low, the capacity development amount was greater than those in the case of Examples 1 and 2, but the capacity retention rate at 80 cycles was exhibited to below.

Additionally, in the case of Comparative Example 2, in which the phase fraction of the rock-salt structure was high due to the excessively formed rock-salt structure, it was confirmed that not only the capacity development amount was significantly lower than those in the case of Examples 1 and 2, but also the capacity retention rate at 80 cycles was exhibited to be significantly low.

In contrast, it was confirmed that Examples 1 and 2 of the present disclosure exhibited a similar level of capacity development amount to that in the case of Comparative Example 1 through the adjustment of the phase fraction of the rock-salt structure but exhibited high capacity retention rates at 80 cycles.

The present disclosure simplifies the preparation process by omitting leachate treatment when preparing the positive electrode active material from the waste battery and directly recycling the waste positive electrode active material solidified from the waste battery to regenerate the positive electrode active material, thus reducing manufacturing costs and significantly improving economic feasibility when recycling the waste battery.

The present disclosure realizes an excellent capacity retention rate by transforming the positive electrode active material regenerated through the adjustment of the Li content in the waste positive electrode active material extracted from the waste battery, into rock-salt structure single crystals, thus improving the performance of the positive electrode active material regenerated from the waste battery, and increases the recycling rate.

Additionally, the present disclosure can reduce manufacturing costs and manufacturing time by uniformly forming single-crystalline particles to have a particle size in the range of 3 μm to 7 μm without requiring a separate grinding process for single-crystal formation.

Although the present disclosure has been described in detail using preferred embodiments, the scope of the present disclosure is not limited to the specific embodiments and should be interpreted in accordance with the appended claims. Additionally, those skilled in the art will understand that various alternatives, modifications, and equivalents are possible without departing from the scope of the present disclosure.

What is claimed is:

1. A method of preparing a positive electrode active material for a secondary battery using a waste battery, the method comprising:
removing a current collector from a waste positive electrode of a waste battery to recover a solidified waste positive electrode active material;
performing a first heat treatment on the recovered waste positive electrode active material to remove a binder and a conductive additive while forming rock-salt structure single crystals by thermal instability; and
performing a second heat treatment at a temperature higher than a first heat treatment temperature to obtain a regenerated positive electrode active material, after the performing of the first heat treatment.

2. The method of claim 1, wherein the removing of the current collector comprises:
a treatment process with sodium hydroxide (NaOH) by immersing the waste positive electrode separated from the waste battery in a NaOH solution to dissolve an aluminum (Al) current collector, thus solidifying the waste positive electrode active material; and
a washing process of the solidified waste positive electrode active material to remove Na and Al residues from the waste positive electrode active material.

3. The method of claim 1, wherein the performing of the first heat treatment is to heat-treat the waste positive electrode active material at a temperature in a range of 400° C. to 600° C. to transform lithium (Li) into the rock-salt structure single crystals,
wherein the heat-treated waste positive electrode active material has a Li content in a range of 49 mol % to 81 mol %.

4. The method of claim 3, wherein after the performing of the first heat treatment, a phase fraction of the rock-salt structure in the waste positive electrode active material is in a range of 31% to 85%.

5. The method of claim 1, wherein the performing of the first heat treatment is to heat-treat the waste positive electrode active material at a temperature in a range of 400° C. to 600° C. to transform Li into the rock-salt structure single crystals,
wherein the heat-treated waste positive electrode active material has a Li content in a range of 49 mol % to 70 mol %.

6. The method of claim 5, wherein after the performing of the first heat treatment, a phase fraction of the rock-salt structure in the waste positive electrode active material is in a range of 43% to 85%.

7. The method of claim 1, further comprising:
adjusting a Li content in the waste positive electrode active material before the performing of the first heat treatment.

8. The method of claim 7, wherein the adjusting of the Li content is to adjust the Li content in the waste positive electrode active material to a range of 49 mol % to 81 mol %.

9. The method of claim 8, wherein the adjusting of the Li content is to determine the Li content in the waste positive electrode active material, recovered by the removing of the current collector, and supplement Li or remove some Li through elution.

10. The method of claim 7, wherein the adjusting of the Li content is to determine a state of charge (SOC) level of the waste battery before the removing of the current collector, and adjust the SOC level of the waste battery to a range of 20% to 60%.

11. The method of claim 7, wherein the adjusting of the Li content is to determine an SOC level of the waste battery before the removing of the current collector, and adjust the SOC level of the waste battery to a range of 40% to 60%.

12. The method of claim 5, wherein the performing of the second heat treatment comprises:
a mixing process of Li by mixing the waste positive electrode active material with a Li source or a Li salt to supplement Li lost from the waste positive electrode active material transformed into the rock-salt structure single crystals; and
a process of performing the second heat treatment through regenerative heat treatment at a temperature in a range of 480° C. to 950° C., the temperature being higher than the first heat treatment temperature, to regenerate the waste positive electrode active material, after the mixing process.

13. A positive electrode active material for a secondary battery using a waste battery, the positive electrode active material being prepared by the method of claim 1.
